(19) United States
(12) Patent Application Publication
(10) Pub. No.: US 2016/0324607 A1
(43) Pub. Date: Nov. 10, 2016

(54) Flossing Tool

(71) Applicant: Flossticks, LLC, Largo, FL (US)

(72) Inventor: Ken Kaye, St. Petersburg, FL (US)

(73) Assignee: FLOSSTICKS, LLC, Largo, FL (US)

(21) Appl. No.: 14/822,451

(22) Filed: Aug. 10, 2015

Related U.S. Application Data
(60) Provisional application No. 62/158,793, filed on May 8, 2015.

(51) Int. Cl. A61C 15/04

(52) U.S. Cl. CPC A61C 15/046

(57) ABSTRACT

A flossing tool includes an elongated handle. An end of the elongated handle has a head end. The head end has a wrapping field that is separated from the elongated handle by a separation bulge and a holding area, such that an end of the floss wedges into the holding area and the wrapping field accepts windings of floss to facilitate flossing between pairs of one's teeth.

### CROSS-REFERENCE TO RELATED APPLICATION

This application claims the benefit of U.S. provisional application No. 62/158,793 filed on May 8, 2015, the disclosure of which is incorporated by reference.

### FIELD

This invention relates to the field of dental hygiene and more particularly to a device for assisting in flossing.

### BACKGROUND

Dental floss is a bundle of thin filaments used to remove food and dental plaque, in particular from between teeth. Flossing, in addition to brushing teeth, has been shown to reduce various tooth diseases and decay. The American Dental Association has advised flossing at least once per day. Further, tooth decay has been linked to other serious diseases such as heart disease.

The floss is typically wrapped around a person's fingers and inserted between the teeth to remove contamination from along the sides of those teeth.

Dental floss is commonly supplied in dispensers that contain 10 to 100 meters of floss. The person pulls out the desired amount of floss and wraps each end of the desired amount of floss around the person's fingers, typically a finger from each hand, though sometimes the person is capable of holding the floss firmly between fingers without wrapping.

Unfortunately, for many people, it is difficult to position the fingers on both sides of some teeth, in particular back teeth. This is especially true for people with large fingers and/or small mouths.

There have been solutions for this, typically comprising an applicator having a fixed, short section of floss firmly held between two extensions, resembling a sling shot where the floss is tightly strung between the extensions. These applicators are more of a convenience for removing food particles after eating and typically fail short for hygiene purposes. Often the small length of floss breaks and/or shreds after use between one or two pairs of teeth, thereby not functioning for all gaps between teeth. Further, the tautness of the floss between the extensions reduces contact with many surfaces of each tooth. It is often better to form an arc with the end of the floss to thoroughly clean all surfaces of the tooth, including curved surfaces. The arc is then reversed to clean all surfaces of the adjacent tooth.

What is needed is a floss applicator that will function for users with any sized fingers and mouths, enabling flossing where flossing was previously difficult or impossible.

### SUMMARY

In one embodiment, a flossing tool is disclosed including an elongated handle. An end of the elongated handle has a head end. The head end has a wrapping field that is separated from the elongated handle by a separation bulge, such that the wrapping field accepts windings of floss to facilitate flossing between pairs of one's teeth.

In another embodiment, a flossing tool is disclosed including an elongated handle. A head end at one end of the elongated handle has a wrapping field that is separated from the remainder of the elongated handle by a separation bulge. A holding area is formed around the wrapping field, having a wedge shape for capturing and holding floss. A spool indentation is formed in the wrapping field for storing one or more turns of floss and an end cap is formed at an end of the head end, having a diameter greater than a diameter of the spool indentation.

In another embodiment, a flossing tool is disclosed including an elongated handle. A head end of the elongated handle has a wrapping field that is separated from the elongated handle by a separation bulge. A holding area is formed around the wrapping field and has a wedge shape for capturing and holding floss. The holding area accepts windings of floss to capture and hold an end of the floss.

In another embodiment, a method of flossing is disclosed including holding a first elongated handle of a first flossing tool in one hand. A first head end is at one end of the first elongated handle and has a first wrapping field that is separated from the first elongated handle by a first separation bulge. The first wrapping field has a first holding area formed around the first wrapping field. The method continues with wrapping and wedging a first end of a length of floss in the first holding area. Now, a second elongated handle of a second flossing tool is held in a different hand. A second head end is at one end of the second elongated handle and has a second wrapping field that is separated from the second elongated handle by a second separation bulge. The second wrapping field has a second holding area formed around the second wrapping field. Now after a second end of the length of floss is wrapped and wedged in the second holding area, the length of floss is pushed between teeth and moved back and forth by moving the first flossing stick and the second flossing stick generally in synchronization.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a plan view of a flossing tool.

FIG. 2 illustrates a plan view of the head end of the flossing tool.

FIG. 3 illustrates a plan view of the opposing end of the flossing tool.

FIG. 4 illustrates a perspective view of the flossing tool in use.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

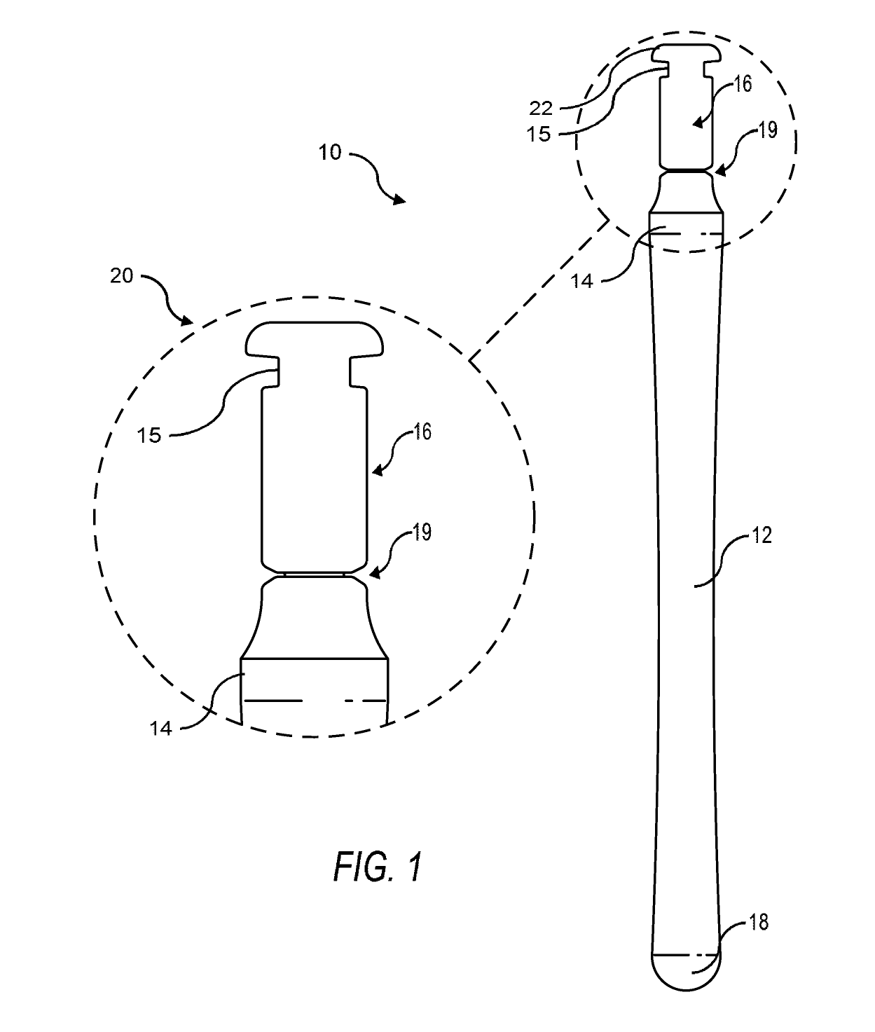

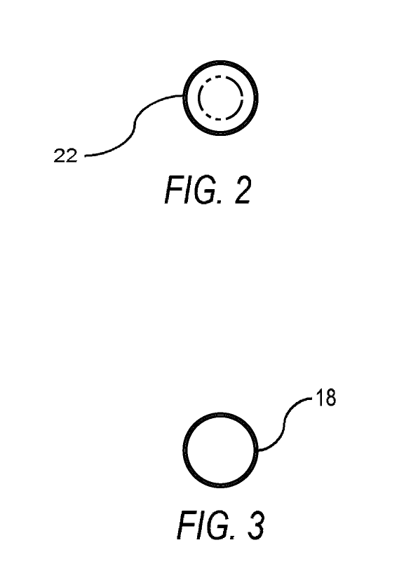

Referring to FIGS. 1 - 3, a schematic view (FIG. 1) and end views (FIGS. 2 and 3) of a flossing tool 10 are shown. The flossing tool 10 includes an elongated handle 12 having, in some embodiments, a rounded (e.g. hemispherical) end 18 for user comfort. At the opposing end of the handle is a head end 20 having a wrapping field 16. Separating the wrapping field 16 from the handle 12 is a separation bulge 14. The separation bulge 14 helps keep floss 30A/30B (see FIG.

4) from unwinding and migrating along the handle 12.

The head end 20 also has a spool area 15 and a holding area 19. In use, the floss 30A/30B is wound around the holding area 19, where the floss 30A/30B wedges between the groove of the holding area 19 and is retained until the floss 30A/30B is unwound, pulling the floss 30A/30B out of the holding area 19.

In a preferred embodiment, the head end 20 also includes a spool indentation 15 that is bordered by an end cap 22. The spool indentation 15 holds an amount of the floss 30A/30B that is wound within the spool indentation 15 and prevented from falling out by the end cap 22.

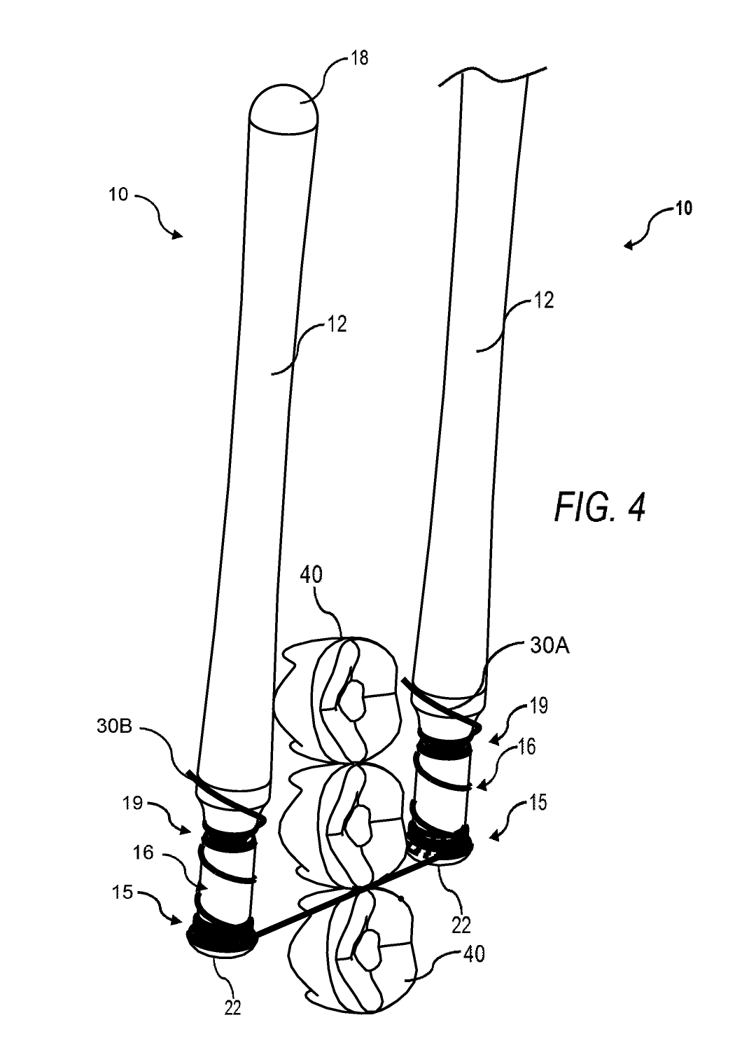

In use, typically two flossing sticks 10 are used together and an amount of floss 30A/30B is wound around the spool indentation 15. After flossing between two teeth 40 (see FIG. 4), each flossing stick 10 is rotated to wrap the used or worn floss 30A/30B around the spool indentation 15 of one of a first floss stick 10 and releasing fresh floss 30A/30B from the spool indentation 15 of the second floss stick 10.

It is also anticipated that one flossing stick 10 is used solo with the user holding one end of the floss 30A in their fingers while the other end of the floss 30B is wrapped around the flossing stick 10.

As shown in FIG. 4, each end of the floss 30A/30B is wrapped and captured (e.g. wedged) in the holding area 19 of respective floss sticks 12. The floss 30A/30B is then wound around the spool indentation 15 and/or the holding area 16. It is anticipated that after the floss 30A/30B is used to clean between a first pair of teeth 40 (or when the floss 30A/30B wears), then the floss 30A/30B is unwound from the spool indentation 15 and/or holding area 16 of one floss stick 12 and wound onto the spool indentation 15 and/or holding area 16 of the second floss stick 12, thereby exposing new floss 30A/30B. The floss 30A/30B is removed from the holding area 19 by unwinding and pulling the floss 30A/30B out of the holding area 19.

Note, in some uses, a distal second end of the floss 30B is wrapped around a user's finger, or left free, depending upon user preference. It is often advantageous to pull the floss 30A/30B back and forth between the teeth 40 to facilitate proper cleaning.

In some embodiments, the flossing tool 10 is fabricated from a stiff material such as plastic, as plastic is more pleasing in a person's mouth than metal, though any stiff material is anticipated. In some embodiments, a soft feel surface if provided to the elongated handle 12, for comfort and grip. Likewise, in some embodiments, the wrapping field is coated or covered with a surface that yields or deforms under pressure of wrapping of floss 30A/30B to better hold the floss 30A/30B during use.

In use, a user wraps one end of the floss 30A around the holding area 19 of a first flossing tool 10 until the end of the floss 30A wedges in the holding area 19. A surplus amount of the first end of the floss 30A is wound around the spool area 22 and/or the wrapping field 16. The user wraps a second end of the floss 30B around the holding area 19 of a second flossing tool 10 until the second end of the floss 30B wedges in the holding area 19 of the second flossing tool 10. Now, the first and second flossing tools 10 are used to push the floss 30A/30B into the spaces between the user's teeth 40 and, as directed, the floss 30A/30B is pulled back and forth cleaning various surfaces of the teeth 40. As the floss 30A/30B wears or when cleaning the next gap between two other teeth 40, some of the surplus amount of the first end of the floss 30A is released and the worn area of floss 30A/30B is wrapped around the spool area 22 and/or the wrapping field 16 of the second flossing tool 10, thereby exposing fresh floss 30A/30B to clean the next gap. This is repeated for all gaps that are to be cleaned with the floss 30A/30B.

The flossing tool(s) 10 provide improved access to the user's teeth 40, particularly the user's back teeth/molars, etc.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A flossing tool comprising:
an elongated handle; and
a head end at one end of the elongated handle, the head end having a wrapping field that is separated from the elongated handle by a separation bulge, and a holding area formed around the wrapping field, the holding area having a wedge shape for capturing and holding floss;
whereas, the holding area accepts windings of floss to capture and hold an end of the floss.

2. The flossing tool of claim 1, further comprising a spool indentation in the wrapping field, the head indentation for storing one or more turns of the floss.

3. The flossing tool of claim 2, wherein an end cap is formed on an end of the head end, the end cap having a diameter greater than a diameter of the spool indentation.

4. The flossing tool of claim 1, wherein the flossing tool is made of plastic.

5. A method of flossing comprising:
holding a first elongated handle of a first flossing tool in one hand, a first head end is at one end of the first elongated handle, the first head end has a first wrapping field that is separated from the first elongated handle by a first separation bulge, and the first wrapping field has a first holding area formed around the first wrapping field;
wrapping and wedging a first end of a length of floss in the first holding area;
holding a second elongated handle of a second flossing tool in a different hand, a second head end is at one end of the second elongated handle, the second head end has a second wrapping field that is separated from the second elongated handle by a second separation bulge, and the second wrapping field has a second holding area formed around the second wrapping field;
wrapping and wedging a second end of the length of floss in the second holding area;
pushing the length of floss between teeth and moving the floss back and forth by moving the first flossing stick and the second flossing stick generally in synchronization.

6. The method of claim 5, further comprising wrapping a surplus amount of the length of floss around the first wrapping area of the first flossing tool.

7. The method of claim 6, further comprising after cleaning between a first pair of the teeth, unwrapping some of the surplus amount of the length of floss from around the first wrapping area of the first flossing tool and wrapping a used portion of the length of floss around the second wrapping area of the second flossing tool; pushing the surplus amount of the length of floss between a second pair of the teeth; and moving the floss back and forth by moving the first flossing tool and the second flossing tool generally in synchronization.

8. The method of claim 5, further comprising a first spool indentation in the first wrapping field of the first floss tool and a second spool indentation in the second wrapping field of the second floss tool.

9. The method of claim 8, further comprising wrapping a surplus amount of the length of floss around the first spool indentation of the first flossing tool.

10. The method of claim 6, further comprising after cleaning between a first pair of the teeth, unwrapping some of the surplus amount of the length of floss from around the first spool indentation of the first flossing tool and wrapping a used portion of the length of floss around the second spool indentation of the second flossing tool; pushing the surplus amount of the length of floss between a second pair of the teeth; and moving the floss back and forth by moving the first flossing tool and the second flossing tool generally in synchronization.

11. The method of claim 8, wherein a first end cap is formed at an end of the first head end and a second end cap is formed at an end of the second head end.

12. A flossing tool comprising:
an elongated handle; and
a head end at one end of the elongated handle, the head end having a wrapping field that is separated from the elongated handle by a separation bulge, a holding area formed around the wrapping field, the holding area having a wedge shape for capturing and holding floss, a spool indentation is formed in the wrapping field, the spool indentation for storing one or more turns of the floss, and an end cap formed at an end of the head end, the end cap having a diameter greater than a diameter of the spool indentation.

13. The flossing tool of claim 12, wherein the flossing tool is made of plastic.
